(19) United States
(12) Patent Application Publication
(10) Pub. No.: US 2007/0260513 A1
(43) Pub. Date: Nov. 8, 2007

(54) System and method for administering a compensation management plan

(75) Inventor: John E. Pavlov, Hopkinton, MA (US)

Correspondence Address: LOWRIE, LANDO & ANASTASI, RIVERFRONT OFFICE, ONE MAIN STREET, ELEVENTH FLOOR, CAMBRIDGE, MA, 02142, US

(73) Assignee: Incentive Systems, Inc., Burlington, MA (US)

(21) Appl. No.: 11/418,833

(22) Filed: May 5, 2006

(51) Int. Cl. G06Q 30/00

(52) U.S. Cl. 705/14

(57) ABSTRACT

At least one aspect is directed to a computer-implemented method and system for administering an incentive based compensation management plan. In one aspect, the method is implemented on a computer system having a display, and the method includes presenting, to a user in the display of the computer system, a plurality of drop-down menus to enable the user to create a compensation management plan based on at least one incentive, accepting an input from the user for at least one parameter of the compensation management plan, presenting on the display an image representing at least a portion of the compensation management plan reflecting the at least one parameter.

### BACKGROUND OF INVENTION

1. Field of Invention

Embodiments of the invention relate generally to compensation management plans and more specifically to a system and method for administering an incentive-based compensation management plan.

2. Discussion of Related Art

A number of compensation management systems having compensation plans are used by various organizations to track the sales performance of employees and determine incentive payments owed to the employees based on the performance. The incentive payments include, for example, commissions paid to a salesman based on the volume of sales made be the salesman. These compensation systems are often home-grown systems that require a high level of technical expertise to operate the systems and/or make any changes to compensation plans of the systems. Typical existing solutions are implemented using either an in-house designed spreadsheet program or a complex custom computer program. Other known systems are available from a number of vendors, however, these systems typically require significant customization by high level technicians or programmers and may be more complex, and accordingly more expensive, than needed by many organizations.

### SUMMARY OF INVENTION

At least one aspect of the invention is directed to a computer-implemented method for administering an incentive based compensation management plan using a computer system having a display. The method includes presenting to a user in the display of the computer system a plurality of drop-down menus to enable the user to create a compensation management plan based on at least one incentive, accepting an input from the user for at least one parameter of the compensation management plan, and presenting on the display an image representing at least a portion of the compensation management plan reflecting the at least one parameter.

The method may also include establishing an override condition for the at least one parameter based on input from the user. The override condition may define an exception to a parameter for a specific payee of the compensation system. Establishing an override condition may include providing an override graphical symbol on the display in proximity to a representation of a parameter for which an override is available. The method may further include displaying a pull-down menu that includes a list of payees in response to selection of the override graphical symbol by the user. The method may further include, based on input from the user, establishing a split rule that defines a function for dividing credit for a sales transaction among two or more payees. The method may include presenting to the user on the display options for filters to define a compensation formula for use in the compensation plan. The method may further include presenting the options for filters using at least one pull-down menu. The method may include displaying on the display a compensation formula that is derived at least in part based on user defined filters.

Another aspect of the invention is directed to a compensation system that includes a display device, and at least one processor coupled to the display device. The at least one processor is programmed to present to a user on the display device a plurality of drop-down menus to enable the user to create a compensation management plan based on at least one incentive, accept an input from the user for at least one parameter of the compensation management plan, and present on the display an image representing at least a portion of the compensation management plan reflecting the at least one parameter.

The at least one processor may be further programmed to establish an override condition for the at least one parameter based on input from the user. The override condition may define an exception to a parameter for a specific payee of the compensation system. Establishing an override condition may include providing an override graphical symbol on the display device in proximity to a representation of a parameter for which an override is available. The at least one processor may be further programmed to display a pull-down menu that includes a list of payees in response to selection of the override graphical symbol by the user. The at least one processor may be further programmed to, based on input from the user, establish a split rule that defines a function for dividing credit for a sales transaction among two or more payees. The at least one processor may be further programmed to present to the user on the display device options for filters to define a compensation formula for use in the compensation plan. The at least one processor may be further programmed to present the options for filters using at least one pull-down menu. The at least one processor may be further programmed to display on the display device a compensation formula that is derived at least in part based on user defined filters. The at least one processor may be programmed to, based on input from the user, establish a split rule that defines a function for dividing credit for a sales transaction among two or more payees.

Another aspect of the invention is directed to a computer-implemented method for administering an incentive based compensation management plan using a computer system having a display. The method includes presenting, to a user in the display of the computer system, a plurality of input boxes to enable the user to create a compensation management plan based on at least one incentive, accepting an input from the user for at least one parameter of the compensation management plan, presenting on the display an image representing at least a portion of the compensation management plan reflecting the at least one parameter, and establishing an override condition for the at least one parameter based on input from the user.

The override condition may define an exception to a parameter for a specific payee of the compensation system. Establishing an override condition may include providing an override graphical symbol on the display in proximity to a representation of a parameter for which an override is available. The method may further include displaying a pull-down menu that includes a list of payees in response to selection of the override graphical symbol by the user.

### BRIEF DESCRIPTION OF DRAWINGS

The accompanying drawings, are not intended to be drawn to scale. In the drawings, each identical or nearly identical component that is illustrated in various figures is represented by a like numeral. For purposes of clarity, not every component may be labeled in every drawing. In the drawings:

FIG. 1 is a functional block diagram of a compensation system in accordance with one embodiment;

FIG. 2 is a diagram of the software architecture of a compensation application in accordance with one embodiment;

FIG. 3 is a flow chart of a call process used in one embodiment;

FIG. 4 shows a display screen of a graphical user interface used in one embodiment;

FIG. 5 shows a status display screen of a graphical user interface used in one embodiment;

FIG. 6 shows a my organization display screen of a graphical user interface used in one embodiment;

FIG. 7 shows a my performance display screen of a graphical user interface used in one embodiment;

FIG. 8 shows a summary display screen of a graphical user interface used in one embodiment;

FIG. 9 shows a basic info display screen of a graphical user interface used in one embodiment;

FIG. 10 shows a pull-down menu used in the display screen of FIG. 9;

FIG. 11 shows a measures display screen of a graphical user interface used in one embodiment;

FIG. 12 shows a second measures display screen of a graphical user interface used in one embodiment;

FIG. 13 shows a filter transaction box of the second measures display screen of FIG. 12;

FIG. 14 shows a filter result which can be displayed on the display screen of FIG. 12.

FIG. 15 shows a third measures display screen of a graphical user interface used in one embodiment;

FIG. 16 shows a fourth measures display screen of a graphical user interface used in one embodiment;

FIG. 17 shows a target box having an override graphical symbol used in one embodiment;

FIG. 18 shows the target box of FIG. 17 after selection of the override graphical symbol;

FIG. 19 shows a commission box after selection of an override graphical symbol;

FIG. 20 shows a process for posting transactions in one embodiment;

FIG. 21 shows a functional block diagram of a computer system that may be used in embodiments of the invention; and

FIG. 22 shows a functional block diagram of a storage system used with the system of FIG. 21.

### DETAILED DESCRIPTION

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” or “having,” “containing”, “involving”, and variations thereof herein, is meant to encompass the items listed thereafter and equivalents thereof as well as additional items.

At least one embodiment of the invention is directed to an incentive based centralized compensation system and method that provides significant advantages over prior systems. Advantages may be realized by employees at different levels or categories including sales compensation analysts, sales representatives and executives, and finance executives. In one embodiment, as described further below, a compensation system is configured to provide different categories of employees with different graphical user interfaces (GUIs) and drop-down menu selections to allow each of the employees to easily gain access to those aspects of the compensation system most applicable to their position.

For compensation analysts, at least one embodiment provides the ability to create, manage and adapt one or more compensation plans to meet the needs of an organization. Creation and modification of compensation plans can be accomplished simply by an analyst without help from programmers or IT personnel. The methods and systems allow an analyst to generate commission reports, provide alerts and warnings, model compensation costs and run historic data analyses to assist in strategic planning for the organization.

For finance executives of an organization, at least one embodiment provides the ability to run sales compensation cost expectations for different scenarios, run historic data analyses and create accurate forecasts.

For sales executives, at least one embodiment provides the ability to analyze strengths and weaknesses of sales plans and teams by providing real-time visibility into the sales performances of team members and individual products. An organization's business strategies may be reinforced through the use of special promotion incentives, which may be incorporated into entire compensation plans or on a per person or per product basis.

For sales representatives, at least one embodiment provides access to day to day commission earnings against targets and provides a sales representative with the ability to drill down to check transaction details and the logic used to calculate commissions.

In one embodiment, as will now be described, a computer based system and method for establishing, maintaining and accessing data in compensation management plans is provided. In one version, a compensation management system is implemented using a web-hosted application that allows authorized users of the system to access the application over the Internet. In other embodiments, other system architectures using networked or local computer systems may be used.

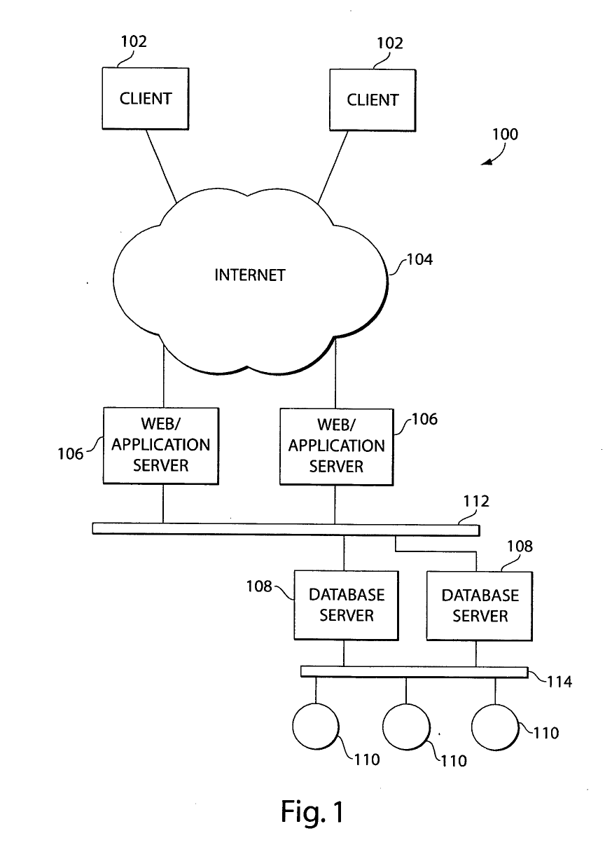

FIG. 1 provides a high level diagram of a networked computer system 100 used in one embodiment of the invention. The system 100 includes a number of client computer systems 102 coupled to the Internet 104. The system 100 also includes web/application servers 106, database servers 108 and database storage devices 110. The web/application servers and database servers are coupled to a local area network 112: The web servers 104 are also coupled to the Internet. The database servers 108 and the database storage devices 110 are coupled to a data network 114. In other embodiments, rather than use separate networks, the data network and/or the local area network may be implemented using the Internet. Further, while shown as separate devices, the functions of two or more of the web/application servers and database servers may be combined in a single device in other embodiments of the invention.

In operation, a user (i.e., a compensation analyst, a sales executive, or a sales representative) uses one of the client computers 102 to access a compensation application over the Internet through one of the web/application servers 106. The compensation application is operative on one or more of the web/application servers 107 in conjunction with one or more of the database servers 108.

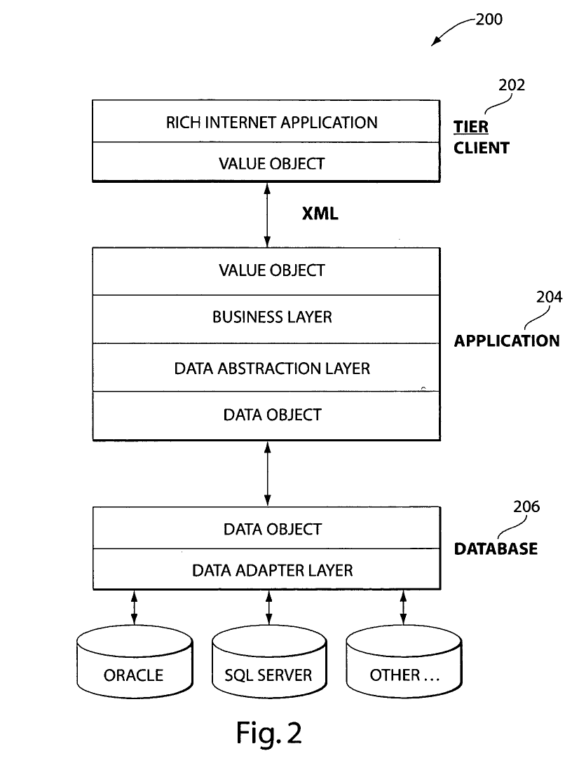

In one embodiment, as will now be described, the compensation application is implemented using a highly scalable, object oriented, J2EE architecture having a user interface that utilizes a rich internet application and a high performance back end that utilizes standard relational databases. FIG. 2 shows a high level representation of the application architecture 200 used in one embodiment of a compensation system. The application has three primary tiers identifies as a client tier 202, an application tier 204 and a database tier 206. The use of a multi-tiered distributed application allows various parts of the application to operate on different devices.

The client tier 202 is implemented in one embodiment using the Macromedia Flex program available from Adobe Systems, Inc. The client tier provides user interface screens for the client computers and receives data input from the client computers.

The application tier 204 includes a business layer that supports client services and implements business logic functions of the application. The application tier also includes a database abstraction layer that functions as a bridge between the business layer and the database tier. In one embodiment, the function of the database layer is database independent. The database layer translates data to and from value objects used by the business layer and data objects used by the data adapter layer of the database tier.

The database tier 206 includes a database adapter layer that formats data from the data abstraction layer in database dependent format. As shown in FIG. 2, in one embodiment, the application 200 is operable with Oracle database systems, SQL Server database systems as well as others.

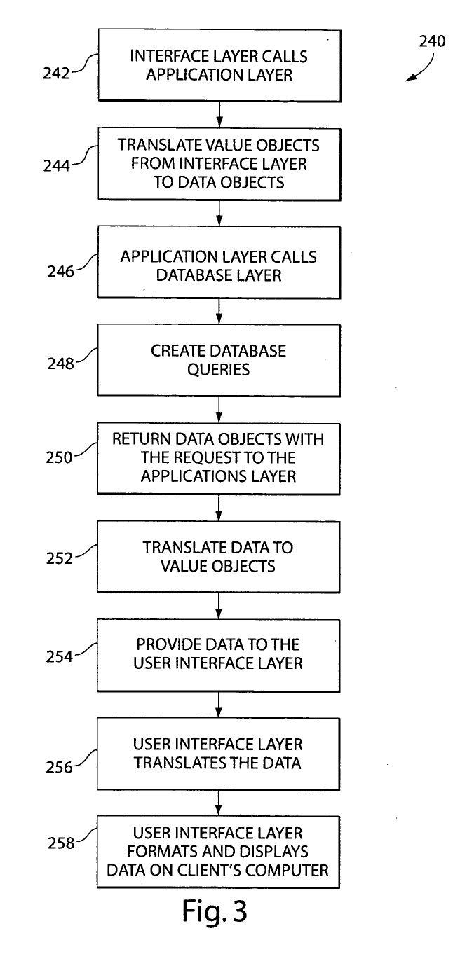

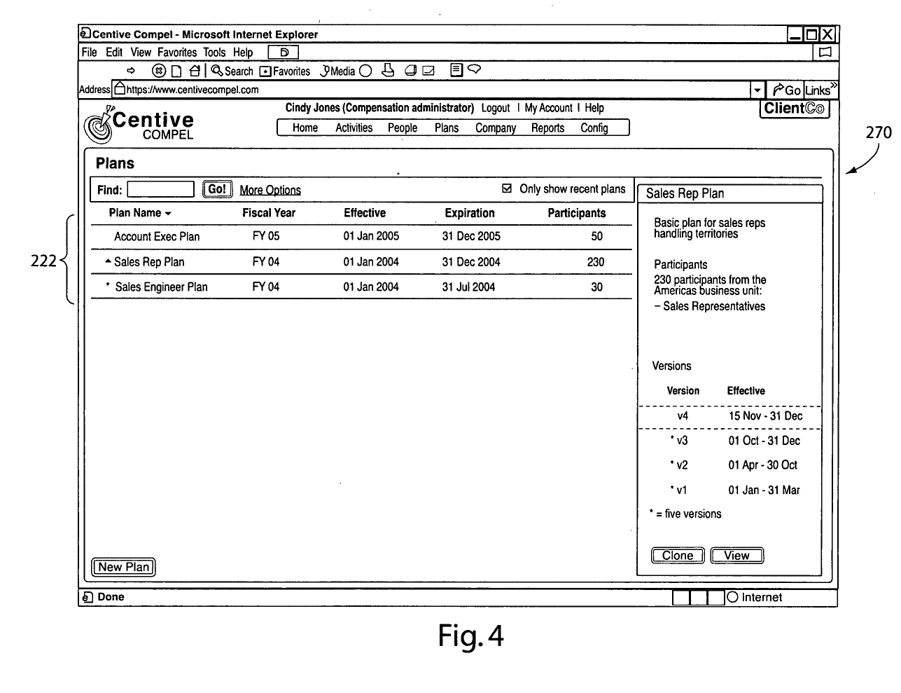

Interactions among the tiers shown in FIG. 2 are implemented using calls. An example of a process for implementing the call structure used in one embodiment will now be described. The example will be described with reference to a process 240, shown in FIG. 3, used by the system to provide to a user on a client computer a user interface screen 270 shown in FIG. 4. The user interface screen 270 provides to the user a list 222 of available compensation plans that may be accessed by the user.

In a first stage 242 of the process 240 in response to an input by the user, the user interface layer creates a call to the application layer to provide a list of compensation plans for the user's business unit based on parameters (i.e., dates of the plans) provided by the user through the GUI. In stage 244, in the application layer, value objects provided by the user interface layer are translated into data objects, and at stage 246 a call is made to the database layer using the data objects to request data to meet the request by the user. In the database layer, database dependent queries are created (stage 248) to obtain the requested data from one or more databases. Data objects containing the requested data are returned to the applications layer at stage at stage 250. The application layer translates the data (stage 252) to value objects recognizable by the user interface layer and provides (stage 254) the data to the user interface layer. In the last stages of the process, the user interface layer translates the data (stage 256) and formats and displays the data on the client's computer (stage 258).

As discussed above, in at least one embodiment, different categories of users are provided different levels of access to the compensation system based on the job function of the user. GUI screens provided to each type of user as well as menu selections available to the user will now be further described for users identified as a compensation administrator, a sales executive, a sales representative, and a power user. As discussed above, in one embodiment, the compensation system is implemented as a web hosted application and a user accesses the system over the Internet using a standard web browser. Upon accessing the system, a user is prompted to provide a user name and password. In one embodiment, based on the user name, the category of user and level or levels of access for the user are determined by the system.

The compensation administrator may be provided access to all areas of the system with the exception of the configuration section (described further below). The compensation administrator is able to import data, manage daily tasks, and disputes from the field (i.e. sales reps.), kick-off commission calculations, export data, run reports and configure and edit compensation plans.

Sales executives and managers may be any user who has directs reports based on a defined organization in a compensation plan. A sales executive may also be a payee that is credited with commissions based on their own performance (sales) or on the performance of their direct reports. As a manager, a sales executive has access to ranking reports (ranking performance of their direct reports) organizational summaries, and all sales data for individuals that report up to the manager in the organization chart of the business. If the sales executive is also a payee under a compensation plan, then the sales executive also has access to all of their own data, similar to a sales representative described below.

Individual sales representatives are users of the system that do not have direct reports, but are payees of a compensation plan. Sales representatives can view their payout history, compare that to targets and estimate future earnings.

A power user has access to all of the information described above for a compensation administrator and also has access to the configuration menu of the system. The power user is able to enter and edit an organization chart of a business, define users, product catalogs, customers (accounts), transaction data definitions, multi-currency settings and default global settings. In some implementations all of the compensation administrators may be power users.

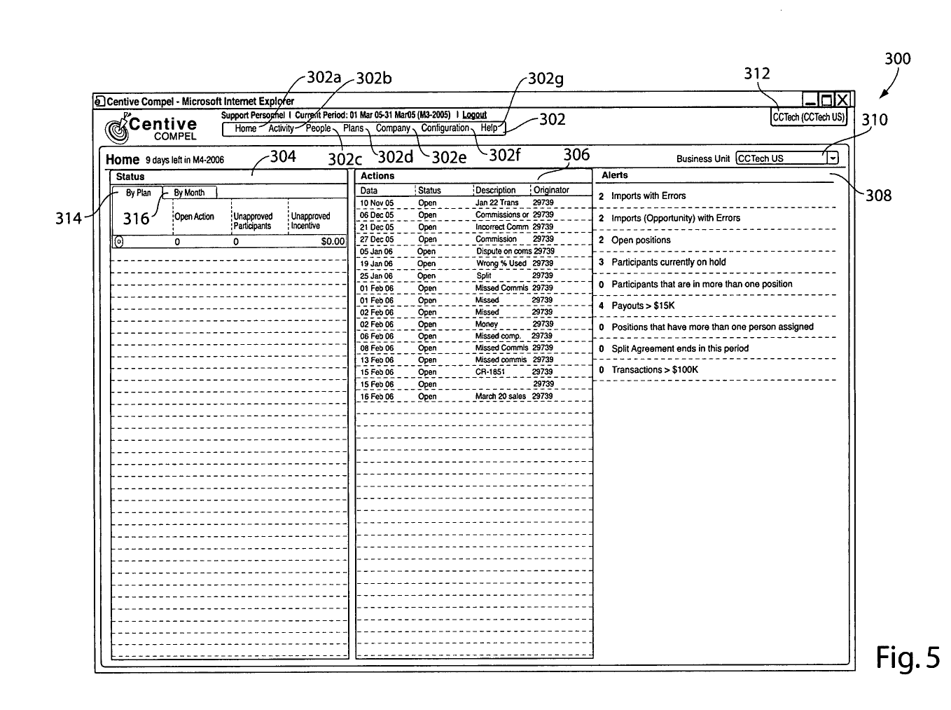

FIG. 5 shows the home page 300 for a compensation administrator in accordance with one embodiment. The home page includes a dashboard 302, a status section 304, an actions section 306, an alerts section 308, a business unit selection button 310 and a business unit identifier 312.

The status section 304 provides status by month or by plan by toggling one of buttons 314 and 316. In the status section, the number of open actions, unapproved participants and unapproved incentives is provided. The open actions count includes open actions for a plan if the action item was created by a participant of a particular plan and the plan has been posted.

The actions section 306 lists the date, status, description and originator of action items. The actions section provides the user with a “quick glance” at the actions to enable the user to identify high priority actions. Action item details can be retrieved using the actions items page under the home menu button on the dashboard. The alerts section 308 provides a user with a quick summary and counts of current alerts or warnings that indicate an undesirable condition, a notable transaction (i.e., greater than $100K) or error.

The business unit selection button allows a user to choose between different business units of their organization. In at least one embodiment, different compensation plans may be developed for different business units of an organization. The business unit identifier 312 shows the name of the organization (CCTech) and selected business unit (CCTech US).

The dashboard 302 of the homepage for the compensation administrator includes 7 menus each of which when selected opens a pull-down menu to provide the user with a number of different options. In the embodiment shown in FIG. 5, the menus include home 302a, activity 302b, people 302c, plans 302d, company 302e, configuration 302f, and help 302g. The home pull-down menu 302a allows a user to return to the home page, when at another page, manage the user's account (i.e. change password or contact information), and access action items. In one embodiment, the dashboard is available to the user on most or all other screens.

The activity pull-down menu allows a user to perform a number of day-to-day tasks including importing and exporting data, posting data, managing adjustments, splits or SPIFFs, viewing President's Club details, obtaining detailed information on transactions or commissions and run reports. Splits are described in more detail below, and in at least one embodiment are used to define rules for splitting commissions under specified circumstances. The term SPIFF is an acronym for “Special Program (or Product) Incentive Fund” and these are typically off-plan promotions or programs created by an organization to motivate a sales group to focus selling in a particular area or product line. The President's Club is one example of an award that may be given to top performers.

The people pull-down menu 302c allows the compensation administrator to obtain details on and manage all aspects of participants in the organization's compensation plans. Through this menu, the administrator can obtain details on participants' discretionary payments, draws, liabilities, holds, releases and payouts.

The plans pull-down menu 302d allows a user to define new compensation plans, modify existing compensation plans, and review characteristics of existing plans. A procedure for building compensation plans in accordance with one embodiment is described further below in greater detail.

The company pull-down menu 302e allows a user to define parameters of the organization that are used in the compensation system and in particular in compensation plans of the compensation system. These parameters are typically entered into the system during an initial setup of the compensation system and not modified often. The parameters defined within the company pull-down include business units, fiscal calendars, customers, corporate objectives, organizational hierarchy, products and teams.

The configuration pull-down menu 302f may be accessible only to a power user or may be accessible to power users and all compensation analysts. Using this menu, a user sets up and customizes the compensation system for use by the organization. With this menu, the user can define management of action items and alerts, data access, payout approvals and report distribution. Formats for the import of data including customer data, position data, product data and transaction data are also defined using these menus.

The help 302g menu leads the user to help screens to get help on various aspects of the compensation system.

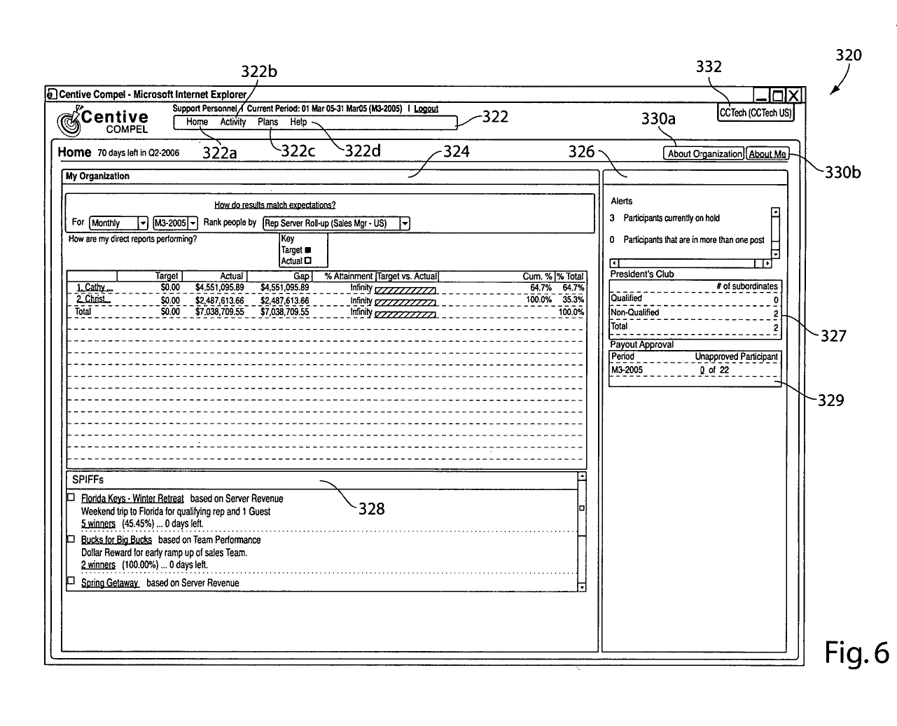

The home page 320 for a user defined as a sales executive or sales manager will now be described with reference to FIG. 6. The home page 320 includes a dashboard 322, a my organization section 324, an alerts section 326, a president's club section 327, a SPIFFs section 328, a payout approval section 329, toggle buttons 330a, 330b, and a business unit identifier 332.

The my organization section 324 provides a list of sales representatives in the sales executive's organization along with a summary of performance for each of the representatives listed. A user has the option of defining different views based on different time periods or by sorting the data using different sorting criteria. Further, by selecting the name of an individual sales representative, the user can obtain further details on the performance and other characteristics of that sales representative.

The alerts section 326, like the alerts section 308 described above, provides a user with a quick summary and count of current alerts or warnings that indicate an undesirable condition, a notable transaction (i.e., greater than $100K), or error.

The president's club section 327 provides an indication of the number of people within the user's organization that have qualified for an incentive program identified as the president's club. In other embodiments, other incentive programs and additional incentive programs may be includes within this section.

The SPIFFs section 328 provides a list of current SPIFFs as well as a summary description of each SPIFF and a count of the number of winners of each SPIFF. Further details for a SPIFF can be obtained by the user by selecting the SPIFF.

The payout approval section 329 provides an indication to the user of whether there are any unapproved payouts for members of his organization.

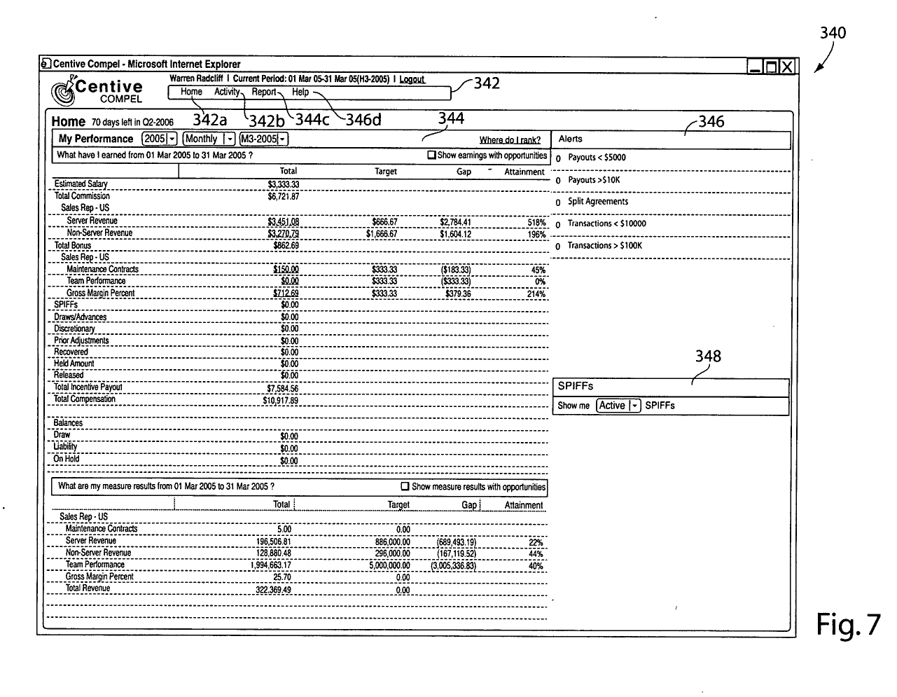

Toggle buttons 330a and 330b allow the user to toggle the home page between an “About me” view and an “About my organization” view, which is the view shown in FIG. 6. The “About me” view provides a summary of the sales executives own performance, and this view is substantially similar to the view provided for a sales representative described below with reference to FIG. 7.

The business unit indicator 332 provides an indication of the sales representative's organization name (CCTech) and business unit (CCTechUS).

The dashboard 322 of the home page for the sales executive is similar to that of the compensation administrator described above, but includes less options. The dashboard 302 includes 4 menus, each of which when selected opens a pull-down menu to provide the user with a number of different options. In the embodiment shown in FIG. 6, the menus include home 322a, activity 322b, plans 322c, and help 322d.

The home pull-down menu 322a allows a user to return to the home page when at another page, manage the user's account (i.e., change password or contact information), and access further detail on action items.

The activity 322b pull-down menu allows the user to see further details on their own compensation and SPIFFs, approve payouts, see further details on president's club information and generate different types of reports.

The plans 322c pull-down menu allows the user to review plan models, which can be used by the compensation administrator to model various scenarios to determine their effect on compensations. Selected models (scenarios) can be made available to a sales executive and used to compare modeled to actual performance.

The help 322d menu leads the user to help screens to get help on various aspects of the compensation system.

The home page 340 for a user defined as a sales representative will now be described with reference to FIG. 7. The home page 340 includes a dashboard 342, a my performance section 344, an alerts section 346, and a SPIFFs section 348.

The my performance section 344 provides a summary of the user's performance for a given time period and can include details on commissions, bonuses and any SPIFFs that have been earned. A user has the option of defining different views based on different time periods or by sorting the data using different sorting criteria.

The alerts section 346, like the alerts sections described above, provides a user with a quick summary and count of current alerts or warnings that indicate an undesirable condition or error.

The SPIFFs section 348 allows the user to view details on current SPIFFs as well as past SPIFFs and upcoming SPIFFs.

The dashboard 342 of the home page for the sales representative is similar to the other dashboards described above, but includes less options. The dashboard 342 includes 4 menus each of which when selected opens a pull-down menu to provide the user with a number of different options. In the embodiment shown in FIG. 7, the menus include home 342a, activity 342b, reports 342c, and help 342d.

The home pull-down menu 342a allows a user to return to the home page when at another page, manage the user's account (i.e., change password or contact information), and access further detail on action items.

The activity pull-down menu 342b allows the user to see further details on their own compensation and SPIFFs.

The reports pull-down menu 344c allows the user to create custom or standard reports for that user's compensation data.

The help pull-down menu 346d leads the user to help screens to get help on various aspects of the compensation system.

In the description of the home page for the compensation administrator above, the dashboard 302 is described as having a plans pull-down menu 302d that can be used to access plans and edit and modify existing plans. A process for building plans using the compensation system in accordance with one embodiment will now be described further. As will be described, in at least one embodiment, the compensation system allows a compensation administrator to simply build and modify compensation plans without requiring advanced knowledge of spreadsheets or computer programming and without help from, for example, the organization's IT staff. In addition, features of compensation plans developed using this process allow a single plan to be used by multiple participants that have varying constraints using an override feature described below.

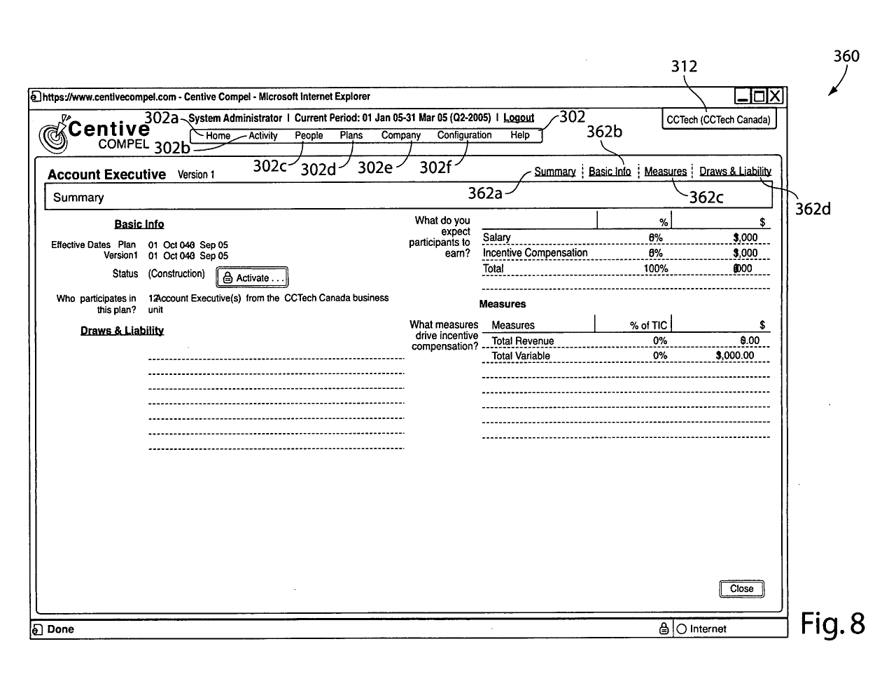

A plan builder user interface of one embodiment will now be described with reference to a compensation plan titled Account Executive and with reference to FIGS. 8-16, which show user interface screens used to build and modify the Account Executive compensation plan. As described above, in one embodiment, the plan builder portion of a compensation system is accessed by a compensation administrator through the plans pull-down menu 302d of the compensation administrator home page. Under the plans pull-down menu, the user can select a current plan or can create a new plan.

Once a plan is selected, a summary page 360, as shown in FIG. 8, is displayed. There are four main screens that can be selected in the plan builder portion of the system. The screens are identified as Summary Screen, Basic Info Screen, Measures Screen and Draws and Liabilities Screen. The screens are selected using toggle buttons 362a, 362b, 362c, and 362d that appear in the upper right hand corner of each of the pages.

The Summary Screen 360 shows all of the main components of the selected compensation plan, including effective date, version, status (under construction or activated), plan participants, draws, liabilities, expected earnings and percentages, and plan measures.

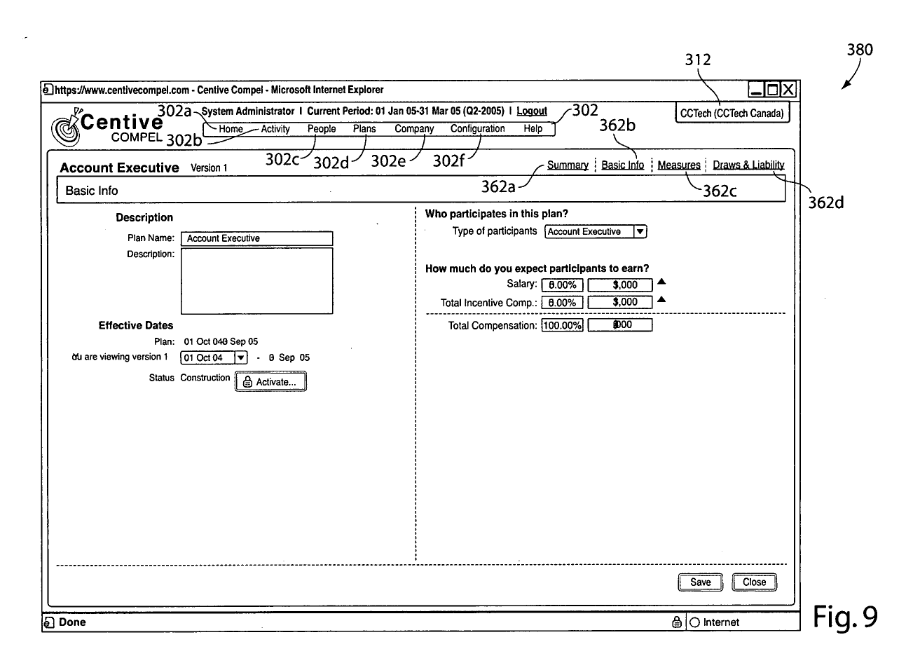

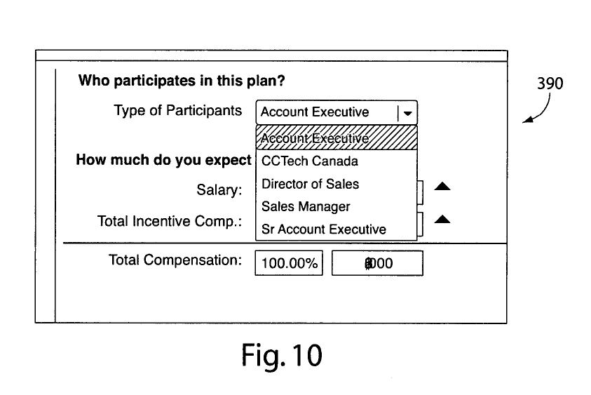

The Basic Info Screen 380 (FIG. 9) allows a user to enter the plan name, description, effective dates, who participates in the plan and expected earnings. In one embodiment, the user is limited in at least some of the selections by the user interface to select one of established definitions to minimize the chance of error. For example, the choice of who participates in the plan (type of participants) is limited to those types defined in the Company pull-down menu. As indicated in the pull-down box 390 in FIG. 10, the user can select Account Executive and a pull-down menu provides the user with the defined user types that can be selected.

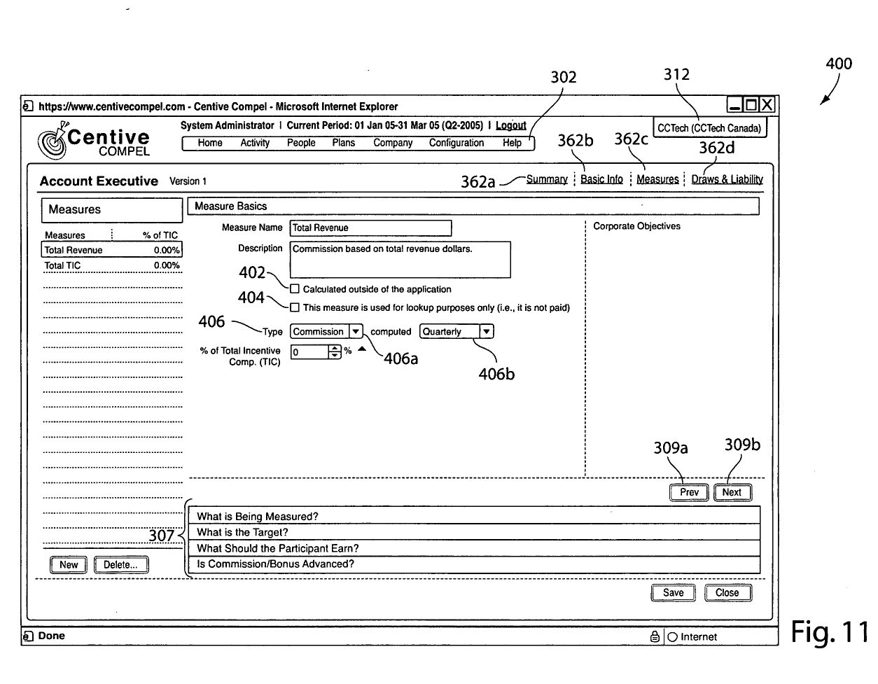

The Measures Screen 400 is shown in FIG. 11. In the Measures Screen, there are five subscreens that may be selected, including Measures Basics, What is Being Measured?, What is the Target?, What Should the Participant Earn?, and Is Commission Being Advanced?. The subscreens can be selected using the buttons 307 or buttons 309a and 309b. In FIG. 11, the subscreen Measures Basics is shown. A measure in one embodiment is a parameter used to calculate compensation based on input transaction values and a calculation defined within the measure. Using the Measures Basics screen, the user is able to enter a measure name, description, type and percentage of total compensation. Checkboxes, i.e., 402 and 404, are used to specify calculation options. One checkbox 402 is used to indicate that the calculation occurs external to the system, and another checkbox 404 is used to indicate that the measure is used for reference purposes only and not to calculate compensation.

In one embodiment, the Measures Basics subscreen 400 provides the user with a unique compensation calculation interface 406 that allows the user to select a type of compensation 406a and a measure frequency 406b without requiring special programming. In one embodiment, the selectable compensation types include bonus and commission and the selectable measure frequencies include annual, quarterly and monthly. In one embodiment, the measure frequency is constrained by a user-defined calendar accessible by a compensation administrator under the Company menu 302f. The measure frequency may include frequencies such as weekly, bimonthly, monthly, quarterly, and annually. The chosen combination, i.e., “commission computed quarterly” is saved and used in commission calculations by the system.

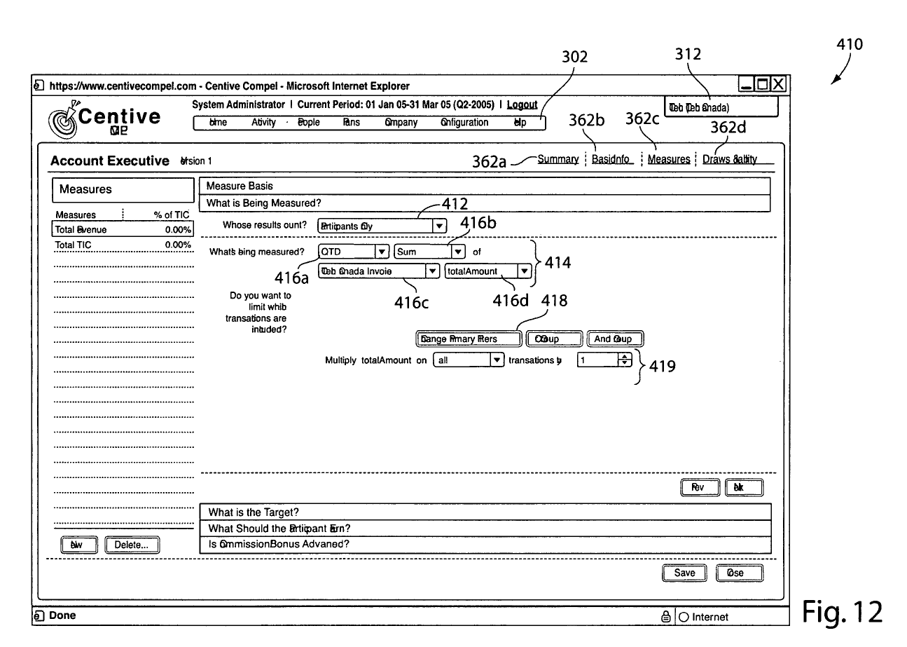

The What is Being Measured subscreen 410 is shown in FIG. 12. Using the What is Being Measured subscreen, the user is able to enter which parameters of which transactions should be processed by this measure. The user is able to limit the measure based on role, time period, type of calculation, and other filters. A Whose Results Count pull-down menu 412 is used to limit the measure by role. The role selections include Participant's Only, Participant's Subordinates, Participant's Team. In other embodiments, other role selections may be available.

A What's Being Measured subsection 414 includes four pull-down menus that define a formula for calculating a value of a measure. In the embodiment shown, the four pull-down menus include a time period menu 416a, a mathematical function menu 416b, a business unit menu 416c and a parameter menu 416d. The time period menu 416a options include quarter to date (QTD), year to date (YTD) and may also include month to date or other time periods. The mathematical function menu 416b includes Sum, Average and Count. Using count each transaction is valued as one count and may have a fixed value. The business unit menu 416c allows the user to include which business units of the organization will be included in the measure calculation. The parameter menu 416D allows a user to select a field of a transaction on which the formula defined in subsection 414 will be performed. For the selected menu items in the What's Being Measured subsection 414 a formula is defined that can be expressed in pseudo code in Equation 1 below.
Select sum(totalAmount) from CCTech_Canada_Invoice (Equation 1)
where type=participant and timePeriod=QTD

Through the user interface, and without requiring any programming, the user is able to define the selection criteria and processing rules and develop a compensation formula.

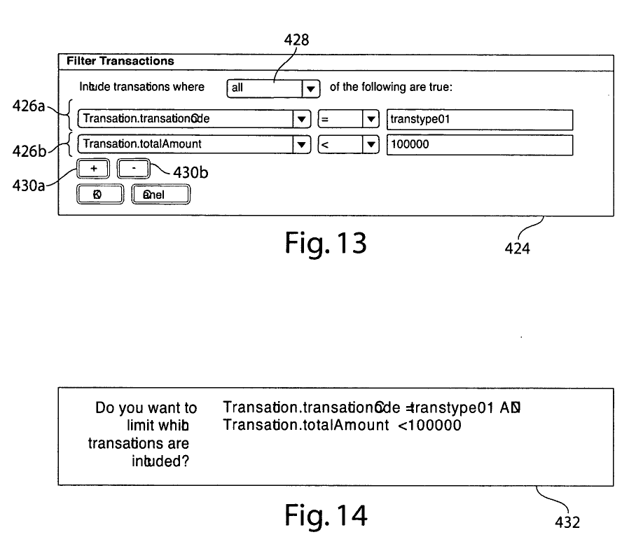

In at least one embodiment, transactions to be included in a calculation can be further limited by filters, using a Change Primary Filters button 418, an Or Group button 420, or an And Group button 422. When the Change Primary Filters button 418 is activated, the screen snippet 424 (see FIG. 13) appears in the What is Being Measured subscreen. Using the screen snippet 424, a user is able to define complex selection criteria for compensation calculations. Logical statements, such as 426a and 426b be can be created to define which types of transactions to include in a compensation calculation and only transactions that are equal to, exceed or less than defined amounts. Using button 428, the user can indicate whether all statements must be true or whether any statements may be true, effectively providing a logical “or” or “and” to the statements. Buttons 430a and 430b are used to add or delete statements in the filters. In one embodiment, as shown in screen snippet 432 (FIG. 14), a logical statement corresponding to the rules implemented by the filters can be displayed on the What is Being Measured subscreen. The effect of the filters on the compensation formula is shown below in pseudo code in Equation 2, which is equivalent to Equation 1 with the filters applied.
Select sum (totalAmount) from CCTech_Canada_Invoice (Equation 2)
where type=participant and timePeriod=QTD
and (transactionCode=transtype01 and totalAmount<100000)
   Using the filters, in at least one embodiment, a user, without knowledge of programming or complex spreadsheet programs, can define complex selection criteria in a compensation formula.

In at least one embodiment, in addition to the use of filters, using a multiplier section 419 (FIG. 12), a user can apply a multiplier to all or select transactions. The multiplier may be greater than one or less than one to provide an increase or decrease in the value of some or all transactions.

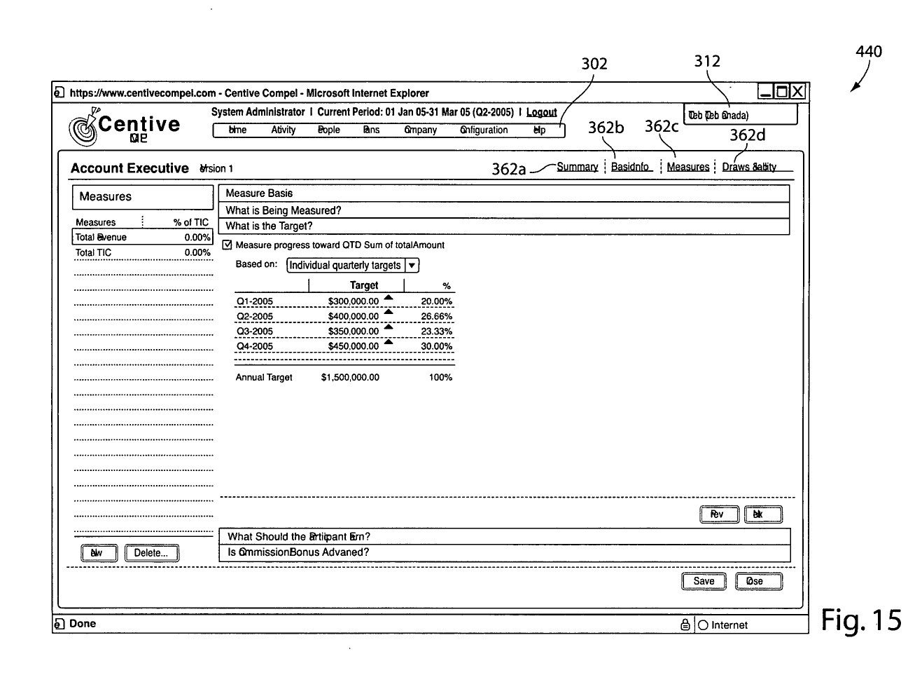

The What is the Target subscreen 440 will now be described with reference to FIG. 15. The What is the Target subscreen allows a user to specify targets according to various parameters including time periods, particular products and particular accounts. In the example shown in FIG. 15, an Account Executive that is compensated using the example plan has an annual sales target of 1,500,000. As shown, the annual total can be distributed unevenly across four quarters to take into account, for example, seasonal variations in sales.

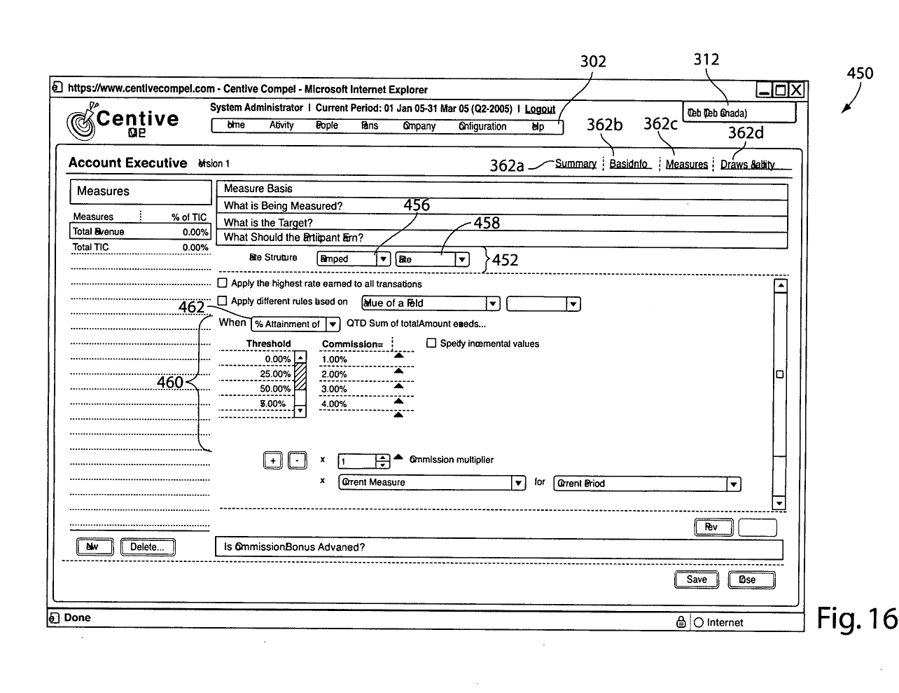

The What Should the Participant Earn subscreen 450 will now be described with reference to FIG. 16. In the What is Being Measured subscreen described above, the measured parameter(s) are defined. In the What Should the Participant Earn subscreen, commission rates or amounts are defined. Using the What Should the Participant Earn subscreen, a user is able to specify the rate structure, rate logic (e.g., apply highest rate to all transactions and/or vary the rate based on another field of a transaction), percentage attainments and threshold/commission values. Additionally, a commission multiplier and time period can be specified, and a cap can be included to cap the total commission for a time period. In a rate structure section 452, the user defines whether the rate is ramped, flat or based on some other formula using pull down menu 456, and using pull-down menu 458 the user defines whether a rate (i.e., percentage) or a fixed amount is used.

When a ramped structure is used (as in the example of FIG. 16), in one embodiment, a section 460 of the screen is opened to allow a user to define the ramped structure based on a criteria (such as QTD Sum of total amount in the example). Using pull-down menu 462, the basis applied to the criteria can be either a percentage of attainment (as shown), a total result or any other basis.

In the example shown in FIG. 16, the user is able to simply specify a ramped rate based on the sum of the transactions to determine the proper commission for an Account Executive.

The Commission/Bonus Advanced subscreen allows the user to define whether advances will be made, and if so, what the advances will be based on (i.e., fixed amount or a percentage of amount earned), and the timing of any advances.

The Draws and Liabilities screen of the plan builder portion of the compensation system allows a user, using pull-down menus, to define draws and provide rules for reconciling any liabilities created due to draws or advances exceeding amounts earned for a plan participant.

As described above, in building a compensation plan in at least one embodiment, various compensation parameters are set for the plan, and various participants may be compensated according to the plan. For the example provided above, a number of account executives may be compensated using the Account Executive compensation plan. In organizations, it is not uncommon for different employees in a same or similar category to be compensated differently based on other criteria (i.e., seniority). In compensation systems of at least one embodiment, different compensation plans can be created to address these individual differences in compensation.

In some cases, the differences in compensation may be small, and it may be undesirable to manage a significant number of compensation plans. In one embodiment of the present invention, a feature identified as overrides may be used to allow a compensation plan to be used by multiple people that have varying criteria or differences in the way that they are compensated. For example, a new sales representative may have a lower total quota and a higher commission rate to account for lack of seniority.

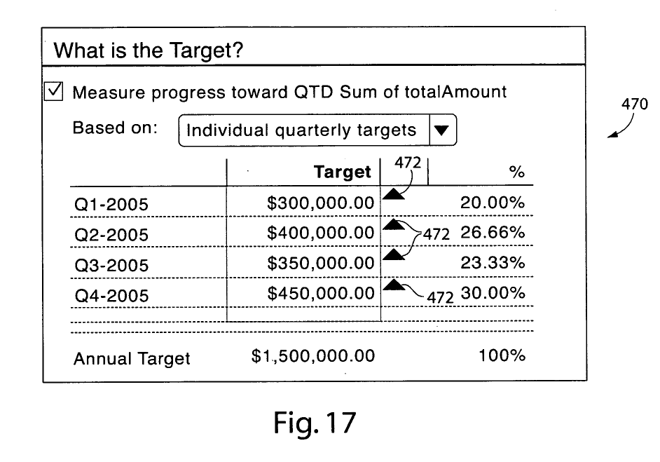

Overrides may be provided for a number of different parameters in a compensation plan. In one example, that will now be described, an override to quarterly targets will be described. In the description above, with reference to FIG. 15, the setting of targets in the Account Executive compensation plan was described. In the above example (without overrides) those targets are the same for all participants of the plan. The use of overrides for targets will be described with reference to FIG. 17, which shows a screen snippet 470 from the What is the Target subscreen. In one embodiment, an override symbol 472 is provided adjacent any parameter for which overrides may be used in a compensation plan. In other embodiments, other symbols or indicators may be used.

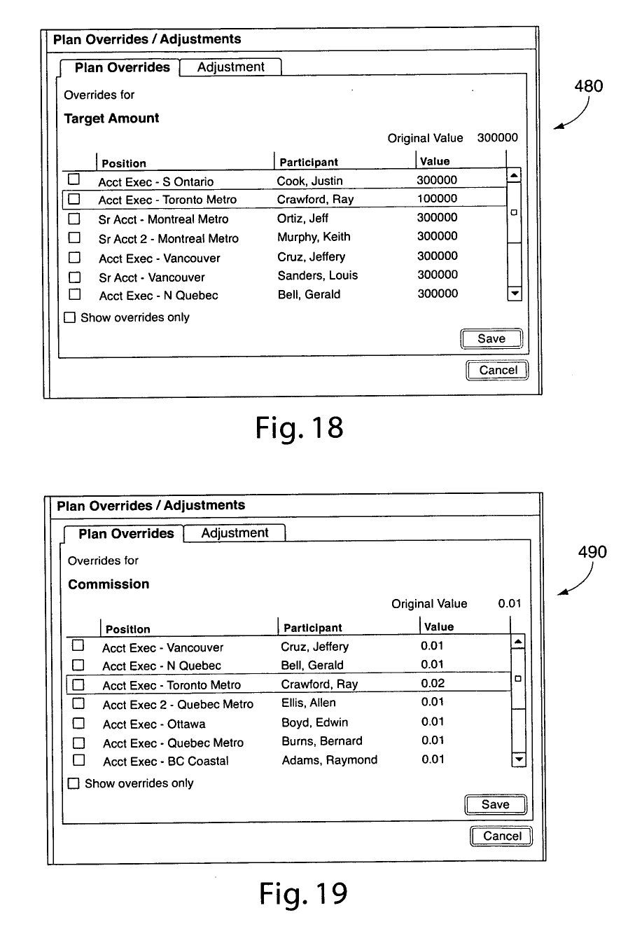

Selection of the override symbol causes a target amount override screen snippet 480 (FIG. 18) to be opened. The particular parameters shown in an override screen snippet may vary depending on the particular parameter that is being overridden. In the target amount override screen, a list of the participants of the selected compensation plan is provided along with the participant's position and the target value for each participant. The target value can be chosen and the value changed for each participant. In the screen snippet 480. the target value for Ray Crawford has been changed to 100,000.

A second example of an override is shown in FIG. 19, which shows a commission override screen snippet 490. Using the commission override screen snippet, a user is able to change the commission for Ray Crawford from a value of 0.01 to 0.02.

In embodiments of the invention, the use of overrides allows one plan to support multiple people and positions. The overrides simplify the building of plans and the management of plans in a compensation system.

In the descriptions of compensation systems of embodiments of the invention provided above, several parameters of the compensation plan are based or calculated based on one or more fields of a transaction record. Typically transaction records include the summary information of a sale or may include total sales results for a given period. Transaction records may be imported into compensation systems of embodiments of the invention automatically, for example daily, or can be imported at the request of, for example, a compensation administrator.

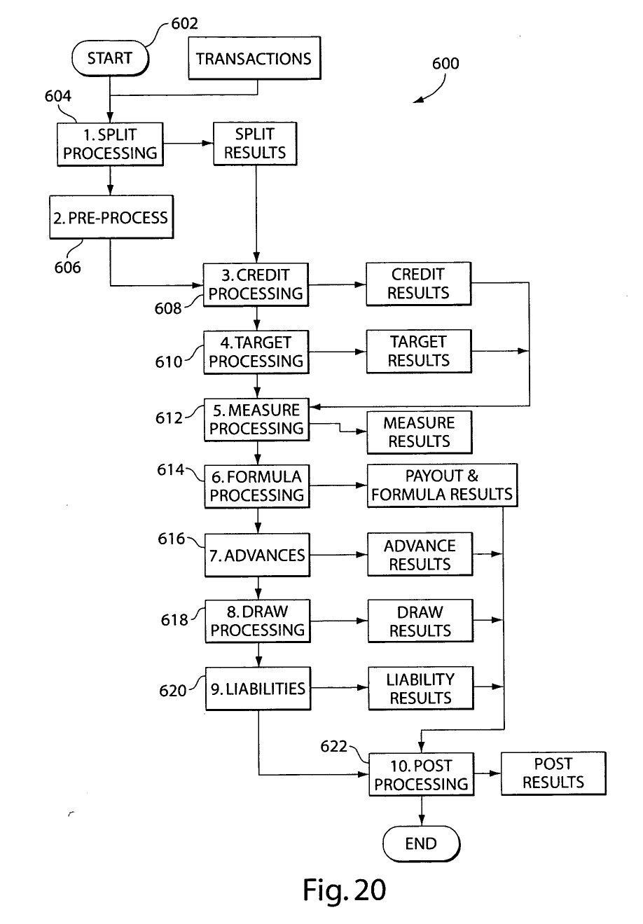

A process 600 for posting transactions in a compensation system will now be described with reference to FIG. 20, which shows a flow chart of the process. The process 600 starts at stage 602 with transaction records being input to the system. At stage 604, split processing occurs where split rules are applied to the transactions to generate one or more split results. In at least one embodiment, split rules may be used in compensation plans to allow a transaction to be credited to one or more people in accordance with split percentages that are applied to the transaction.

Next, in a pre-process stage 606, all unapproved results from previous transaction posts are cleared. In at least one embodiment, an administrator or sales executive is required to approve the posting of transactions.

The remaining stages of the process 600, are performed for each combination of a plan and period being processed. At stage 608, credit processing occurs. Credit processing includes applying credit rules that were defined by the plan builder during the creation or modification of a compensation plan. In one embodiment, there are three types of credits assignments, direct, team, and rollup. With direct assignments, on a measure by measure basis, all split results (obtained from stage 604) meeting the base criteria (i.e., salesid of the transaction matches the payee in the plan, and the effective date of the transaction is in the measure period of the plan) as well as meeting user defined criteria (i.e., the AccountId of the transaction=a user defined account id) have credit result records created for each payee and for this plan/measure combination.

For team assignments, on a measure by measure basis, all split results meeting the base criteria and other user defined criteria have credit result records created for each payee and for this plan/measure combination. For the base criteria, for example, the salesid of the transaction matches a team member of a payee in the plan and the effective date of the transaction is within the date range of the measure period of the plan.

For rollup credits, on a measure by measure basis, all measure results or payout results of a direct report of a payee, have credit result records created for the payee and for this plan/measure combination. In this process, for proper rollup credits to occur, posts are performed in accordance with the organizational structure starting from the bottom, so that direct reports are reported first.

At the next stage 610 in the process, all quotas for a measure are created. The quotas are “target” records that are maintained at the plan/measure/payee level. In addition, if the target is segments, the records will also be segmented at the same level. For example, there may be different targets for different products, and if so, then the records may be grouped by product for calculation and analysis.

Measure processing occurs next at stage 612. Inputs to this stage include the credit results from stage 608 and the target results from stage 610, and the output from the stage is measure results. At this stage, all credit results are summarized at the lowest level of segmentation of the target or formula. During this stage, any targets are also applied to compute attainment percentage.

At the next stage 614 in the process, all formula rules are applied to the measure results and any caps are applied and payout and formula results are obtained.

At stage 616, advance results are generated. If a measure has a measure period that exceeds the payout frequency, a user can define an advance rule for a measure. For example, a year to date (YTD) measure may be calculated monthly. Using advance rules, each payee may be given an “advance” against a year-end payout. The final period (i.e., the last month in a YTD measure) is identified as a true-up period. At the final month, all previous advances are totaled and subtracted from the YTD payout of the measure. If the resulting payout is negative, indicating that the payee was advanced more over the year than he/she was ultimately entitled to, then a liability is created.

Draw processing occurs at stage 618 of the process 600. In compensation plans of embodiments of the invention, rules can be created to provide a draw for a fixed period of time. Draws may be used, for example, to provide income to a new sales person, prior to payout of commissions. The rules created may be associated with the length of time in a position, i.e., the value of a draw may be different for each month and stop after six months. At the end of the draw period, draw payments can be recovered against earned payout.

At the next stage 620 of process 600, any liabilities are recovered based on recovery rules established during the creation of the compensation plan. Liabilities may be created due to advances, draws, plan adjustments and transaction adjustments. The recovery rules may, for example, limit any recovery to a certain total for a given period or a percentage of payout for a period. Any remaining balance of a liability can be recovered in subsequent periods.

In the final stage 622 of process 600, post processing occurs. In at least one embodiment, in post processing, one record is created for each period and category (i.e., categories may include salary, commission, bonus, award, advance, advance recovery, draw, draw recovery, asset payout, liability recovery). All commissions (payout results) are summarized into one record, and all advances, advances recovery and liability recovery have a record created for each category.

The process 600 described above provides for crediting of transactions to individual payees and generates payout for payees. In other embodiments of the invention, other posting processes may be used.

Various embodiments according to the invention may be implemented on one or more computer systems as discussed above. For example, compensation systems may be implemented in a single computer system or in multiple computer systems, including using a web-based application as discussed above. These computer systems may be, for example, general-purpose computers such as those based on Intel PENTIUM-type processor, Motorola PowerPC, Sun UltraSPARC, Hewlett-Packard PA-RISC processors, or any other type of processor.

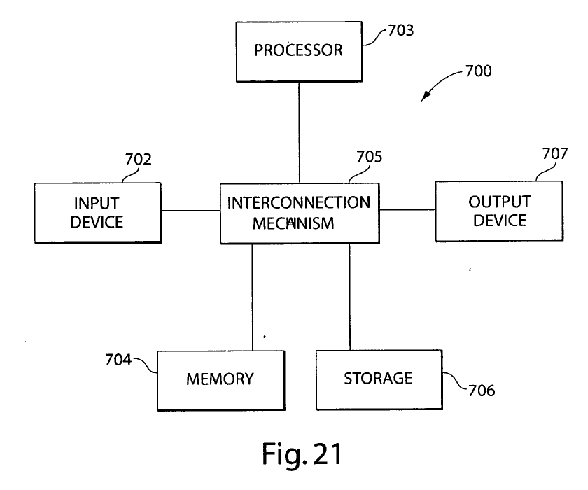

For example, various aspects of the invention may be implemented as specialized software executing in a general-purpose computer system 700 such as that shown in FIG. 21. The computer system 700 may include a processor 703 connected to one or more memory devices 704, such as a disk drive, memory, or other device for storing data. Memory 704 is typically used for storing programs and data during operation of the computer system 700. The computer system 700 may also include a storage system 706 that provides additional storage capacity. Components of computer system 700 may be coupled by an interconnection mechanism 705, which may include one or more busses (e.g., between components that are integrated within a same machine) and/or a network (e.g., between components that reside on separate discrete machines). The interconnection mechanism 705 enables communications (e.g., data, instructions) to be exchanged between system components of system 700.

Computer system 700 also includes one or more input devices 702, for example, a keyboard, mouse, trackball, microphone, touch screen, and one or more output devices 707, for example, a printing device, display screen, speaker. In addition, computer system 700 may contain one or more interfaces (not shown) that connect computer system 700 to a communication network (in addition or as an alternative to the interconnection mechanism 705).

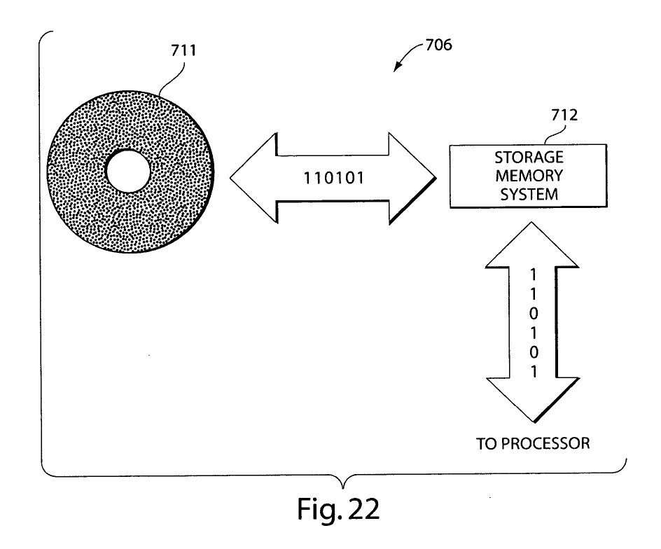

The storage system 706, shown in greater detail in FIG. 22, typically includes a computer readable and writeable nonvolatile recording medium 711 in which signals are stored that define a program to be executed by the processor or information stored on or in the medium 711 to be processed by the program to perform one or more functions associated with embodiments described herein. The medium may, for example, be a disk or flash memory. Typically, in operation, the processor causes data to be read from the nonvolatile recording medium 711 into another memory 712 that allows for faster access to the information by the processor than does the medium 711. This memory 712 is typically a volatile, random access memory such as a dynamic random access memory (DRAM) or static memory (SRAM). It may be located in storage system 706, as shown, or in memory system 704. The processor 703 generally manipulates the data within the integrated circuit memory 704, 712 and then copies the data to the medium 711 after processing is completed. A variety of mechanisms are known for managing data movement between the medium 711 and the integrated circuit memory element 704, 712, and the invention is not limited thereto. The invention is not limited to a particular memory system 704 or storage system 706.

The computer system may include specially-programmed, special-purpose hardware, for example, an application-specific integrated circuit (ASIC). Aspects of the invention may be implemented in software, hardware or firmware, or any combination thereof. Further, such methods, acts, systems, system elements and components thereof may be implemented as part of the computer system described above or as an independent component.

Although computer system 700 is shown by way of example as one type of computer system upon which various aspects of the invention may be practiced, it should be appreciated that aspects of the invention are not limited to being implemented on the computer system as shown in FIG. 21. Various aspects of the invention may be practiced on one or more computers having a different architecture or components shown in FIG. 21. Further, where functions or processes of embodiments of the invention are described herein (or in the claims) as being performed on a processor or controller, such description is intended to include systems that use more than one processor or controller to perform the functions.

Computer system 700 may be a general-purpose computer system that is programmable using a high-level computer programming language. Computer system 700 may be also implemented using specially programmed, special purpose hardware. In computer system 700, processor 703 is typically a commercially available processor such as the well-known Pentium class processor available from the Intel Corporation. Many other processors are available. Such a processor usually executes an operating system which may be, for example, the Windows 95, Windows 98, Windows NT, Windows 2000 (Windows ME) or Windows XP operating systems available from the Microsoft Corporation, MAC OS System X operating system available from Apple Computer, the Solaris operating system available from Sun Microsystems, or UNIX operating systems available from various sources. Many other operating systems may be used.

The processor and operating system together define a computer platform for which application programs in high-level programming languages are written. It should be understood that embodiments of the invention are not limited to a particular computer system platform, processor, operating system, or network. Also, it should be apparent to those skilled in the art that the present invention is not limited to a specific programming language or computer system. Further, it should be appreciated that other appropriate programming languages and other appropriate computer systems could also be used.

One or more portions of the computer system may be distributed across one or more computer systems coupled to a communications network. For example, various aspects of the invention may be distributed among one or more computer systems configured to provide a service (e.g., servers) to one or more client computers, or to perform an overall task as part of a distributed system. For example, various aspects of the invention may be performed on a client-server or multi-tier system that includes components distributed among one or more server systems that perform various functions according to various embodiments of the invention. These components may be executable, intermediate (e.g., IL) or interpreted (e.g., Java) code which communicate over a communication network (e.g., the Internet) using a communication protocol (e.g., TCP/IP).

It should be appreciated that the invention is not limited to executing on any particular system or group of systems. Also, it should be appreciated that the invention is not limited to any particular distributed architecture, network, or communication protocol.

Various embodiments of the present invention may be programmed using an object-oriented programming language, such as SmallTalk, Java, C++, Ada, or C# (C-Sharp). Other object-oriented programming languages may also be used. Alternatively, functional, scripting, and/or logical programming languages may be used. Various aspects of the invention may be implemented in a non-programmed environment (e.g., documents created in HTML, XML or other format that, when viewed in a window of a browser program, render aspects of a graphical-user interface (GUI) or perform other functions). Various aspects of the invention may be implemented as programmed or non-programmed elements, or any combination thereof.

In at least one embodiment of the invention described above, compensation plans are described as having certain features and providing certain benefits. As understood by those skilled in the art, not all embodiments include all features and benefits. Further, in describing certain embodiments, titles have been provided to certain users, i.e., compensation administrators. All embodiments are not limited for use to certain types of users.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A computer-implemented method for administering an incentive based compensation management plan using a computer system having a display, the method comprising:
presenting to a user in the display of the computer system a plurality of drop-down menus to enable the user to create a compensation management plan based on at least one incentive;
accepting an input from the user for at least one parameter of the compensation management plan; and
presenting on the display an image representing at least a portion of the compensation management plan reflecting the at least one parameter.

2. The method of claim 1, further comprising establishing an override condition for the at least one parameter based on input from the user.

3. The method of claim 2, wherein the override condition defines an exception to a parameter for a specific payee of the compensation system.

4. The method of claim 2, wherein establishing an override condition includes providing an override graphical symbol on the display in proximity to a representation of a parameter for which an override is available.

5. The method of claim 4, further comprising displaying a pull-down menu that includes a list of payees in response to selection of the override graphical symbol by the user.

6. The method of claim 5, further comprising, based on input from the user, establishing a split rule that defines a function for dividing credit for a sales transaction among two or more payees.

7. The method of claim 6, further comprising presenting to the user on the display options for filters to define a compensation formula for use in the compensation plan.

8. The method of claim 7, further comprising presenting the options for filters using at least one pull-down menu.

9. The method of claim 8, further comprising displaying on the display a compensation formula that is derived at least in part based on user defined filters.

10. The method of claim 1, further comprising, based on input from the user, establishing a split rule that defines a function for dividing credit for a sales transaction among two or more payees.

11. The method of claim 1, further comprising presenting to the user on the display options for filters to define a compensation formula for use in the compensation plan.

12. The method of claim 11, further comprising presenting the options for filters using at least one pull-down menu.

13. The method of claim 12, further comprising displaying on the display a compensation formula that is derived at least in part based on user defined filters.

14. The method of claim 1, wherein the at least one parameter includes at least one of a commission rate, a target value and a draw amount.

15. A compensation system comprising:
a display device; and
at least one processor coupled to the display device, the at least one processor being programmed to:
present, to a user on the display device a plurality of drop-down menus to enable the user to create a compensation management plan based on at least one incentive;
accept an input from the user for at least one parameter of the compensation management plan; and
present on the display an image representing at least a portion of the compensation management plan reflecting the at least one parameter.

16. The compensation system of claim 15, wherein the at least one processor is further programmed to establish an override condition for the at least one parameter based on input from the user.

17. The compensation system of claim 16, wherein the override condition defines an exception to a parameter for a specific payee of the compensation system.

18. The compensation system of claim 17, wherein establishing an override condition includes providing an override graphical symbol on the display device in proximity to a representation of a parameter for which an override is available.

19. The compensation system of claim 18, wherein the at least one processor is further programmed to display a pull-down menu that includes a list of payees in response to selection of the override graphical symbol by the user.

20. The compensation system of claim 19, wherein the at least one processor is further programmed to, based on input from the user, establish a split rule that defines a function for dividing credit for a sales transaction among two or more payees.

21. The compensation system of claim 20, wherein the at least one processor is further programmed to present to the user on the display device options for filters to define a compensation formula for use in the compensation plan.

22. The compensation system of claim 21, wherein the at least one processor is further programmed to present the options for filters using at least one pull-down menu.

23. The compensation system of claim 22, wherein the at least one processor is further programmed to display on the display device a compensation formula that is derived at least in part based on user defined filters.

24. The compensation system of claim 15, wherein the at least one processor is programmed to, based on input from the user, establish a split rule that defines a function for dividing credit for a sales transaction among two or more payees.

25. The compensation system of claim 15, wherein the at least one processor is further programmed to present to the user on the display device options for filters to define a compensation formula for use in the compensation plan.

26. The compensation system of claim 25, wherein the at least one processor is further programmed to present the options for filters using at least one pull-down menu.

27. The compensation system of claim 26, wherein the at least one processor is further programmed to display on the display device a compensation formula that is derived at least in part based on user defined filters.

28. The compensation system of claim 15, wherein the at least one parameter includes at least one of a commission rate, a target value and a draw amount.

29. A computer-implemented method for administering an incentive based compensation management plan using a computer system having a display, the method comprising:
presenting, to a user in the display of the computer system, a plurality of input boxes to enable the user to create a compensation management plan based on at least one incentive;
accepting an input from the user for at least one parameter of the compensation management plan;
presenting on the display an image representing at least a portion of the compensation management plan reflecting the at least one parameter; and
establishing an override condition for the at least one parameter based on input from the user.

30. The method of claim 29, wherein the override condition defines an exception to a parameter for a specific payee of the compensation system.

31. The method of claim 29, wherein establishing an override condition includes providing an override graphical symbol on the display in proximity to a representation of a parameter for which an override is available.

32. The method of claim 31, further comprising displaying a pull-down menu that includes a list of payees in response to selection of the override graphical symbol by the user.
